(19) United States
(12) Patent Application Publication
(10) Pub. No.: US 2012/0182681 A1
(43) Pub. Date: Jul. 19, 2012

(54) PROTECTION KIT FOR AN INFORMATION CARRIER

(76) Inventor: Jou-Tzu Chen, Taipei City (TW)

(21) Appl. No.: 13/006,152

(22) Filed: Jan. 13, 2011

(51) Int. Cl. G06F 1/16

(52) U.S. Cl. 361/679.31

(57) ABSTRACT

The present invention discloses a protection kit which is used for sheathing and protecting a surface of a mobile information carrier and is adapted to connect normally for communication. The protection kit utilizes a shock-proof cartridge which buffers an external force to be combined correspondingly with an adapter seat which leads to communication, so as to form full protection and enclosure. Besides, the protection kit can be adapted outward to connect normally for communication; whereas, upper and lower surfaces of the adapter seat and the shock-proof cartridge are provided respectively with a male-and-female latching design to facilitate collecting plural information carriers in a stack.

### BACKGROUND OF THE INVENTION

a) Field of the Invention

The present invention relates to a kit for protecting an outer surface of a mobile information access carrier and normally connecting to transmit information, with a collection function in a stack.

b) Description of the Prior Art

Information application has been an indispensable part in modern life, and related data application has been evolved to personal data. Due to a limitation of memory storage capacity of information equipment such as a laptop computer, a portable information carrier such as a mobile disk has been extended. The mobile disk is able to receive a huge amount of messages and is an independent unit. An outer casing of the mobile disk is enclosed by a metallic shell and to beautify appearance, it is commonly seen that an exterior part of the mobile disk is provided with a kit of outer casing made by plastic extrusion to form a single-unit mobile apparatus. Recently, to stimulate an aesthetic sense of sight, shape of the outer casing is constantly renovated and thus, a very large production cost is resulted. Therefore, some vendors only provide a bare disk without the outer casing. This bare disk can be directly installed in a laptop computer or provide for sheathing with other outer casing to form a mobile information carrier.

In addition, a single unit with an outer sheath is popular in existing markets. This single unit is independent and includes a plastic or aluminum casing, an interior of which is a holding space. An interior of the holding space is provided with a structure for latching the metallic outer casing of the bare disk that the contained bare disk can be fixed mechanically. As the single unit and the bare disk are assembled rigidly, there is some miss in anti-collision and shock absorption.

### SUMMARY OF THE INVENTION

The primary object of the present invention is to provide a kit which is used for sheathing and protecting a mobile information carrier and is able to be adapted for normal communication. An upper and lower surface of the kit assembly is provided respectively with male-and-female sheathing structures to facilitate collection in a stack.

A second object of the present invention is to provide a protection kit for an information carrier, wherein an upper surface of an adapter seat is provided with tenons and a lower surface thereof is provided with receiving portions. The tenons and the receiving portions are sheathed in a male-and-female relation for stacking plural sets of the protection kit, wherein plural tenons are arranged in a series to stagger overlapped positions.

A third object of the present invention is to provide a protection kit for an information carrier, wherein an upper surface of a shock-proof cartridge is provided with mortars and a lower surface thereof is provided with foot piers. The mortars and the foot piers are sheathed in a male-and-female relation for stacking plural sets of protection kit; whereas, the shock-proof cartridge is made by a flexible material and is provided with capabilities of mechanical buffering and heat dissipating. Besides, voided gaps of the foot piers can allow air flow to pass through.

A fourth object of the present invention is to provide a protection kit for an information carrier, wherein the adapter seat is provided with a joining surface to be engaged with a joining surface of the shock-proof cartridge, with a result of engagement being to achieve dust-proofing or water-proofing.

A fifth object of the present invention is to provide a protection kit for an information carrier, wherein total height of the adapter seat is the same as that of the shock-proof cartridge, allowing the kit assembly to be stably emplaced on a plane.

A sixth object of the present invention is to provide a protection kit for an information carrier, wherein a bottom surface of the kit assembly forms a skid-proof effect that the kit assembly can be fixed on a desktop easily.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an external view of the present invention before assembling.

FIG. 2 shows a side view of the present invention before assembling.

FIG. 3 shows a side view of the present invention after assembling.

FIG. 4 shows a schematic view of a top-and-down stacking relation of the present invention.

FIG. 5 shows a side view of the top-and-down stacking relation of the present invention.

FIG. 6 shows a schematic view of the present invention which is overlapped from front to back.

FIG. 7 shows a schematic view of another embodiment of the adapter seat of the present invention.

FIG. 8 shows a front view of the present invention, wherein the adapter seats are stacked top-and-down.

FIG. 9 shows a front view of the present invention, wherein plural adapter seats are overlapped as bricks.

### DETAILED DESCRIPTION OF THE PREFERRED EMBODIMENTS

The present invention provides a protection kit which is used for sheathing and protecting an outer surface of a mobile information carrier and which is adapted for communication, wherein a flexible shock-proof cartridge which is capable of buffering an external force is assembled correspondingly with an adapter seat which leads to communication, thereby forming a kit assembly which is provided with full protection and enclosure, and can be adapted outward to be used in normal connection for communication.

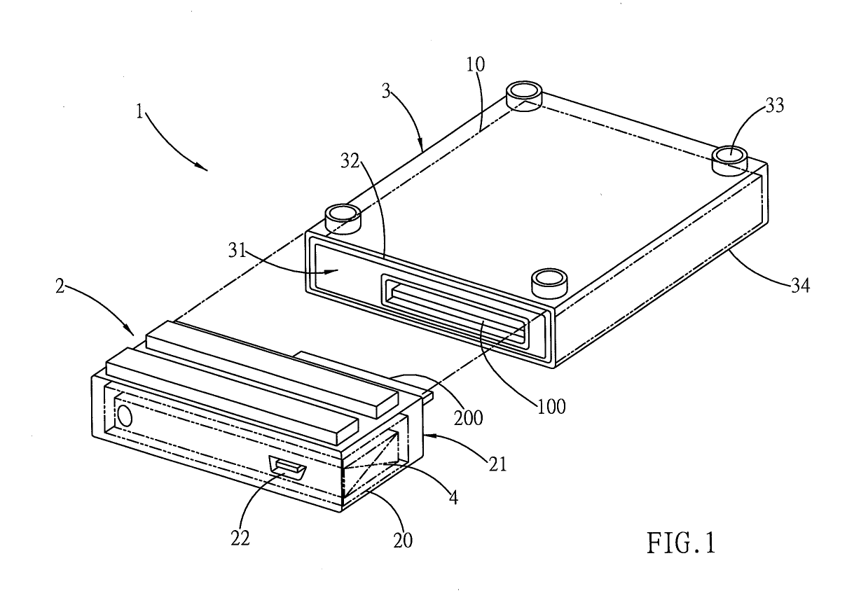

Referring to FIG. 1, a kit assembly 1 of the present invention comprises an adapter seat 2 and a shock-proof cartridge 3. The adapter seat 2 is provided with a joining surface 21, an interior thereof is formed with an installation space 20 and the adapter seat 2 is provided outward with a jack 22. A connection port 200 is formed in a direction of the joining surface 21 and an interior of the installation space 20 provides for installing a circuit 4. The circuit 4 is connected forward to the jack 22 and backward to the connection port 200, with a function for electricity transformation. The jack 22 is in comply with a specification of a regular USB (Universal Serial Bus) slot and the connection port 200 corresponds to a terminal end 100 which complies to a special specification of a mobile information carrier 10.

The mobile information carrier 10 can be put in from an opening 32 of the shock-proof cartridge 3. After being put in, the mobile information carrier 10 is connected with the shock-proof cartridge 3 as one unit by an elastic binding force of the shock-proof cartridge 3. A side of the shock-proof cartridge 3 opposite to the adapter seat 2 is formed with a joining surface 31 which is aligned and connected with the joining surface 21.

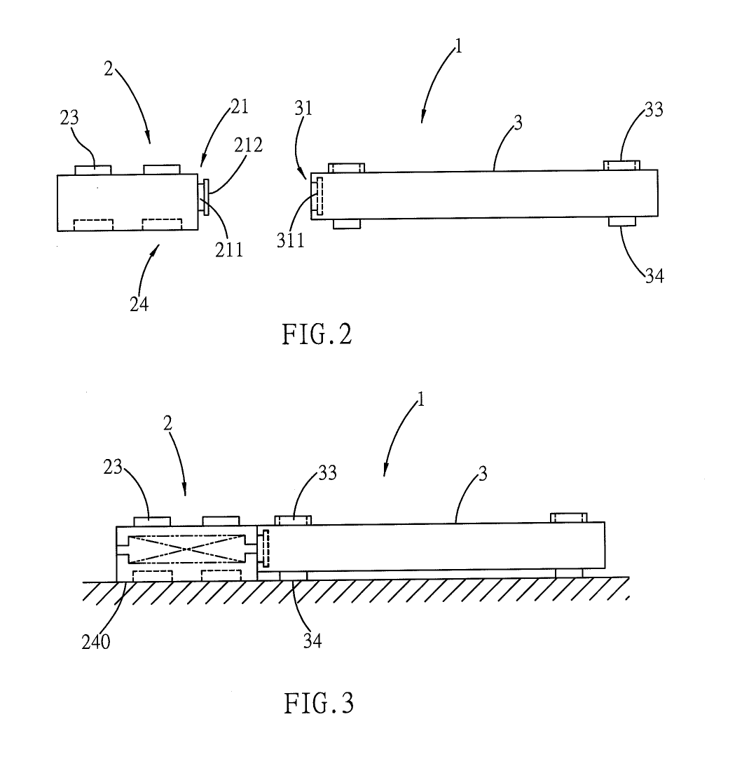

Referring to FIG. 2 and FIG. 3, by engaging the joining surface 21 of the adapter seat 2 with the joining surface 31 of the shock-proof cartridge 3, the kit assembly 1 is formed. An interior of the kit assembly 1, as shown in FIG. 1, is installed respectively with the circuit 4 and the mobile information carrier 10 (to facilitate description, the present drawings will not disclose the provision of the circuit 4 and the mobile information carrier 10 again). An upper surface of the adapter seat 2 is formed with tenons 23 and a bottom surface thereof is formed with receiving portions 24. The tenons 23 and the receiving portions 24 are sheathed in a male-and-female relation. An upper surface of the shock-proof cartridge 3 is formed with mortars 33 and a lower surface thereof is extended with foot piers 34. The mortars 33 and the foot piers 34 are sheathed in a male-and-female relation, and their positions can be interchanged.

After combining the adapter seat 2 with the shock-proof cartridge 3, the kit assembly 1 is formed; whereas, after combining, a bottom plane 240 of the adapter seat 2 is located on the same plane as that of the foot piers 34 of the shock-proof cartridge 3.

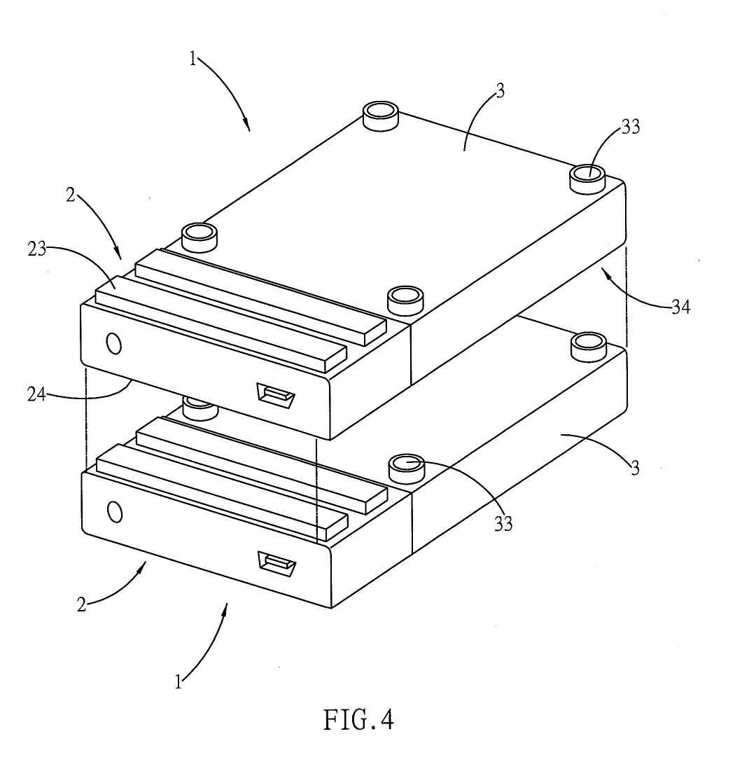

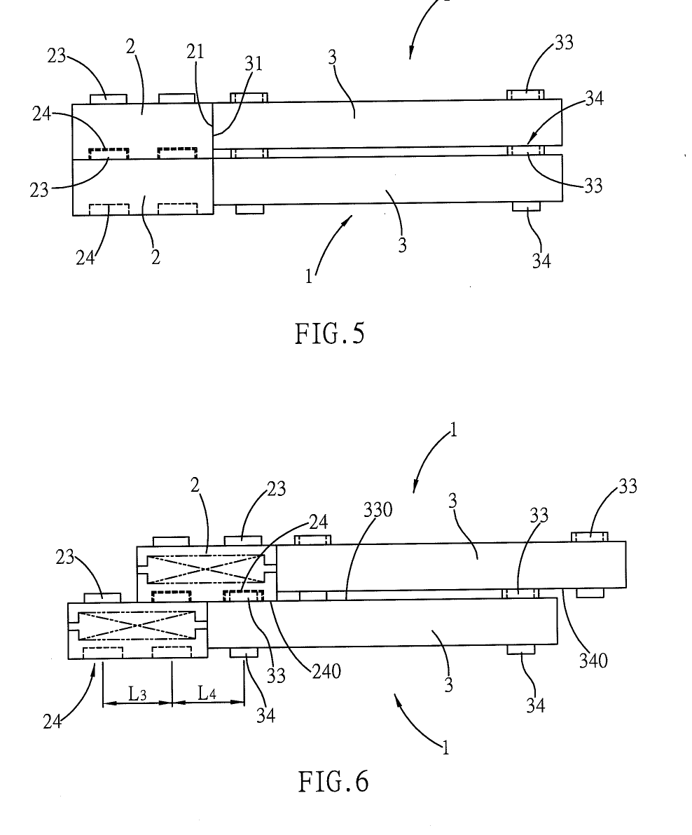

Referring to FIG. 4 and FIG. 5, the kit assembly 1 of the present invention is formed by combining the adapter seat 2 with the shock-proof cartridge 3. The upper side of the adapter seat 2 is provided with the tenons 23 and the bottom side thereof is provided with the receiving portions 24 that are sheathed in the male-and-female relation with the tenons 23. The upper surface of the shock-proof cartridge 3 is provided with the mortars 33 and the lower surface thereof is provided with the foot piers 34 that are sheathed in the male-and-female relation with the mortars 33. In addition, the mortars 33 are provided respectively at four corners of the shock-proof cartridge 3; whereas, the tenons 23 of the adapter seat 2 are equally distributed on the upper surface. By using the male-and-female sheathing relations between the tenons 23 and the receiving portions 24 as well as between the mortars 33 and the foot piers 34, two sets of kit assembly 1 can be stacked on each other, followed by utilizing the sheathing relations between the tenons 23 and the receiving portions 24 as well as between the mortars 33 and the foot piers 34 to latch and combine in layers, thereby facilitating collecting plural information carriers.

Referring to FIG. 2 again, an annular port 212 and a biting port 311 are provided respectively between the joining surface 21 of the adapter seat 2 and the joining surface 31 of the shock-proof cartridge 3. The annular port 212 is formed by extending a neck portion 211 from the adapter seat 2. On the other hand, the biting port 311 is integrally formed with a main body of the shock-proof cartridge 3, and thus, is provided with an elastic deformation capability, forming a biting function to the annular port 212. By combining the biting port 311 with the annular port 212, an effect of dust-proofing or transient water-proofing can be achieved and a connection force between the shock-proof cartridge 3 and the adapter seat 2 can be increased. If there are no annular port 212 and the biting port 311, the connection between the adapter seat 2 and the shock-proof cartridge 3 is only dependent upon a combining force between the connection port 200 and the terminal end 100 (as shown in FIG. 1).

Referring to FIG. 3 again, after combining, each bottom of the adapter seat 2 and the shock-proof cartridge 3 will be located on the same plane. As the shock-proof cartridge 3 is made by an elastic material, a mechanical buffering protection function will be formed and a function of heat conduction or heat dissipation can be implemented. As the formed foot piers 34 are extended downward from bottoms of smaller portions of the shock-proof cartridge 3, an elevated space will be formed at a large residual area at the bottom of the shock-proof cartridge 3, providing for air flow to pass through, so as to assist with the heat dissipation. The foot piers 34 are integrally formed with the shock-proof cartridge 3 and are similarly made by a flexible material; therefore, the shock-proof cartridge 3 can form a skid-proofing effect to a surface of emplacement, such as a desktop.

Referring to FIG. 6, according to the above-mentioned implementation, two kit assemblies 1 can be aligned top-and-down and overlapped in layers. In the present invention, more than two tenons 23 that are provided by the adapter seat 2 can be further arranged front to back equidistantly; therefore, a front-and-rear staggered overlapping configuration can be formed. On the other hand, the receiving portions 24 of the adapter sear 2 at an upper layer will be crossed on the mortars 33 of the shock-proof cartridge 3 of the kit assembly 1 at a lower layer.

Therefore, the mortars 33 and the tenons 23 are arranged equidistantly by, such as spans L₃, L₄. Besides, as being snapped by the receiving portion 24, the mortar 33 is a little smaller than the receiving portion 24; whereas, as being sheathed in the mortar 33, the foot pier 34 is in turn a little smaller than the mortar 33.

A top surface of the mortar 33 of the shock-proof cartridge 3 is aligned with a top surface of the tenon 23 of the adapter seat 2; therefore, both surfaces are on the same plane. In addition, under the condition that the kit assemblies 1 are stacked top-and-down, height of this plane can be the same as that of a bottom plane 340 of the shock-proof cartridge 3; whereas, the bottom plane 240 of the adapter seat 2 at an upper layer is crossed on a top plane 330 of the shock-proof cartridge 3 at a lower layer, after being alternately stacked. Accordingly, in terms of the total height, the mortar 33 is at the same plane as that of the tenon 23, and the foot pier 34 is at the same plane as that of the receiving portion 24.

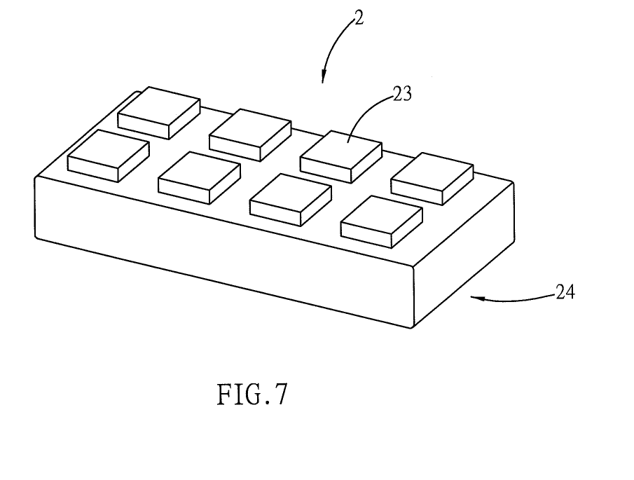

Referring to FIG. 7, plural tenons 23 of the adapter seat 2 can be arranged linearly in a series or arranged as a matrix, with that the bottom receiving portions 24 correspond to the arranged space of the tenons 23, forming the same equidistant snapping function.

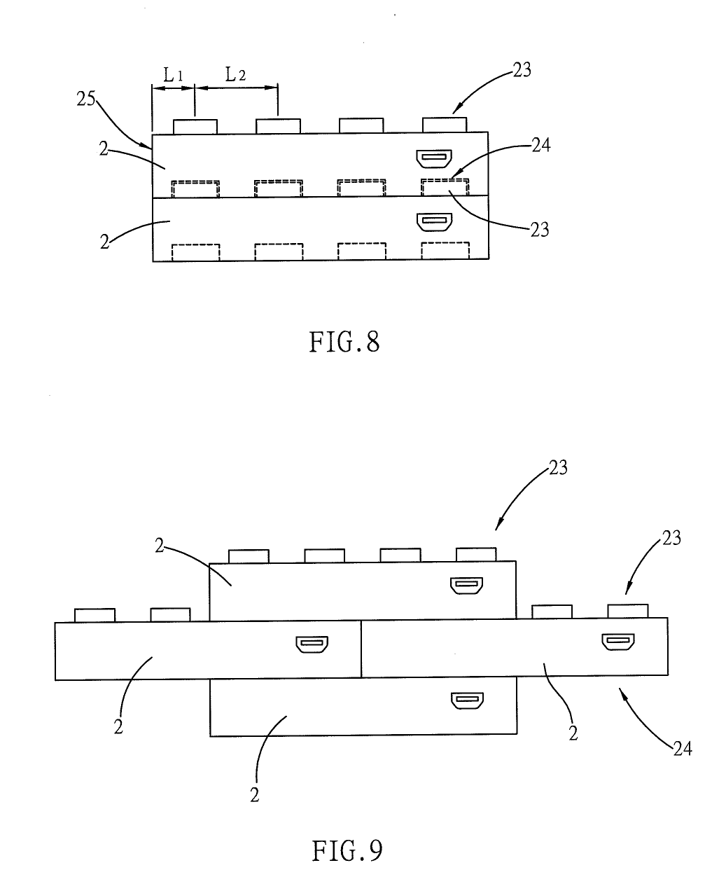

Referring to FIG. 8, the tenons 23 above the adapter seat 2 are arranged by spacing of a span L₂; whereas, a distance from a center line of the tenon 23 adjacent to a side bank 25 of the adapter seat 2 to that side bank 25 is L₁ which is smaller than a half of the span L₂, and the receiving portions 24 and the tenons 23 are engaged in the male-and-female relation as described above. By the above-mentioned arrangement, a brick stack as shown in FIG. 9 can be formed, wherein the receiving portions 24 at the bottom of the adapter seat 2 at the toppest layer are sheathed at a conjugated center of the left and right adapter seats 2 in the middle layer, whereas the adapter seat 2 at the bottomest layer, like the toppest adapter seat 2, is loaded on the conjugated center of two adapter seats 2 in the middle layer, and so forth. Therefore, plural overlapped configurations can be formed to collect in all new or old information carriers or information carriers of various storage capacities, with a beautiful and lively appearance.

In the present invention, the kit assembly 1 is formed after connecting the adapter seat 2 with the shock-proof cartridge 3 to achieve the effects of mechanical shock-wave protection and skid-proofing. In addition, the upper and lower surfaces of the adapter seat 2 and the shock-proof cartridge 3 are provided respectively with the tenons 23, receiving portions 24, mortars 33 and foot piers 34, achieving the use of top-and-down stacking.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A protection kit for an information carrier which provides for sheathing and protecting a mobile information carrier and is adapted for normal communication, comprising:
an adapter seat, which is provided with a joining surface and an interior of which is provided with a circuit installation space, with that the installed circuit is connected outward to a regular USB (Universal Serial Bus) slot, a connection port is connected toward a direction of the joining surface, an upper surface of the adapter seat is provided with tenons and a bottom thereof is provided with receiving portions; and
a shock-proof cartridge, having total height the same as that of the adapter seat, which is provided forward with a joining surface, with that the joining surface is connected with an opening, the opening is connected inward with a holding space, an upper surface of the shock-proof cartridge is provided with mortars and a lower surface thereof is provided with foot piers.

2. The protection kit for an information carrier according to claim 1, wherein the shock-proof cartridge is made by an elastic and flexible material.

3. The protection kit for an information carrier according to claim 1, wherein the joining surface of the adapter seat is protruded with a neck portion and an outer end of the neck portion is provided with an annular port to provide for engaging with a biting port at the joining surface of the shock-proof cartridge.

4. The protection kit for an information carrier according to claim 1, wherein the tenons and the receiving portions are sheathed in a male-and-female relation, and plural tenons are arranged in a series.

5. The protection kit for an information carrier according to claim 1, wherein the tenons and the receiving portions are sheathed in a male-and-female relation, and plural tenons are arranged in a matrix.

6. The protection kit for an information carrier according to claim 4, wherein the tenons in a series are spaced equidistantly with each other.

7. The protection kit for an information carrier according to claim 5, wherein the tenons in a matrix are spaced equidistantly with each other.

8. The protection kit for an information carrier according to claim 4, wherein a distance from a center of the tenon adjacent to a side bank to that side bank is a half of the spacing thereof.

9. The protection kit for an information carrier according to claim 5, wherein a distance from a center of the tenon adjacent to a side bank to that side bank is a half of the spacing thereof.

10. The protection kit for an information carrier according to claim 1, wherein positions of the tenons and the mortars are interchanged.

11. The protection kit for an information carrier according to claim 1, wherein height of the mortar is a smaller than that of the tenon.

12. The protection kit for an information carrier according to claim 1, wherein height of the foot pier is the same as that of the tenon.
